(19) United States
(12) Patent Application Publication
(10) Pub. No.: US 2014/0081737 A1
(43) Pub. Date: Mar. 20, 2014

(54) SYSTEM AND METHOD FOR REAL-TIME DISCOUNTS AT POINT OF SALE

(71) Applicants: Andrea Christine Gilman, Chappaqua, NY (US); Andrew Guiney, Fenton, MO (US); Lisa Yates, Ballwin, MO (US)

(72) Inventors: Andrea Christine Gilman, Chappaqua, NY (US); Andrew Guiney, Fenton, MO (US); Lisa Yates, Ballwin, MO (US)

(73) Assignee: MASTERCARD INTERNATIONAL INCORPORATED, Purchase, NY (US)

(21) Appl. No.: 13/622,129

(22) Filed: Sep. 18, 2012

(51) Int. Cl. G06Q 30/02

(52) U.S. Cl. 705/14.36

(57) ABSTRACT

A method for processing a real-time discount at a point of sale includes: storing, in a database, a plurality of deals, each deal including a consumer identification and a transaction modifier; receiving an authorization request for a financial transaction, the authorization request including a consumer identifier and a transaction amount; verifying enrollment in a discount service of a consumer associated with the consumer identifier; identifying, in the database, at least one deal of the plurality of deals where the included consumer identification corresponds to the consumer identifier; calculating a new transaction amount based on the transaction amount and the transaction modifier included in the at least one deal; and transmitting, by a transmitting device, an authorization response for the financial transaction, wherein the authorization response is for the new transaction amount and is indicated as being a final authorization rather than a partial authorization.

### FIELD

The present disclosure relates to real-time discounts at point of sale, specifically processing a real-time discount for a deal or offer by adjusting the purchase amount by the payment processor prior to authorization.

### BACKGROUND

In recent times, coupons, deals, offers, and other discounts have become an even greater part of marketing efforts by merchants and manufacturers. Offering consumers a deal can result in an increase in revenue, and a repeat customer that could result in even greater gains over a period of time. Deals also provide an avenue of exposure of a merchant or manufacturer to consumers that may not have been aware of the merchant or manufacturer prior to the deal, or may convince an apprehensive consumer to transact with the entity when they otherwise may not have.

Traditionally, coupons and other deals often came in the form of paper coupons sometimes with machine-readable codes, often included in newspapers and magazines. To redeem such a coupon, a consumer would have to obtain a copy of the newspaper or magazine, locate the coupon, remove or “clip” the coupon, take it to the merchant, and then present it to the merchant as part of the checkout process. However, because of the large number of steps, consumers could often forget or misplace coupons prior to their being used. In order to make the process easier for consumers, and due to the prevalence of smart phones and other mobile devices, some merchants and manufacturers have begun to use electronic coupons. These electronic coupons would contain machine-readable codes and could be stored on the mobile device and used similar to traditional paper coupons. Like with traditional coupons, however, consumers were still required to locate the coupons, save them in the mobile device, and then present them when checking out.

To further facilitate consumers, a more recent method for processing coupons and deals includes associating the deal with a payment card belonging to the consumer. When the consumer engages in a transaction and uses the payment card, a payment card processor can identify that the consumer has a deal and, once the transaction is processed, issue a credit to the consumer for the value of the deal. This can be more effective than traditional print and electronic coupons, as it requires significantly less effort on the part of the consumer. However, the issuing of a credit on the consumer's account means that the transaction is still for the full amount, and that the discount is not seen by the consumer until after the transaction, and sometimes not until the next account statement. In such methods, it may both needlessly tie up funds on a consumer's account, and may confuse the consumer to know whether or not a certain deal has already been redeemed.

Thus, there is a need for a technical solution to processing a discount associated with a consumer account at the point-of-sale without the need for the processing of a second financial transaction.

### SUMMARY

The present disclosure provides a description of a system and method for processing real-time discounts at the point of sale.

A method for processing a real-time discount at a point of sale includes: storing, in a database, a plurality of deals, wherein each deal includes at least a consumer identification and a transaction modifier; receiving, by a receiving device, an authorization request for a financial transaction, wherein the authorization request includes at least a consumer identifier and a transaction amount; verifying, by a processing device, enrollment in a discount service of a consumer associated with the consumer identifier; identifying, in the database, at least one deal of the plurality of deals where the included consumer identification corresponds to the consumer identifier; calculating, by the processing device, a new transaction amount based on the transaction amount and the transaction modifier included in the at least one deal; and transmitting, by a transmitting device, an authorization response for the financial transaction, wherein the authorization response is for the new transaction amount, and wherein the authorization response is indicated as being a final authorization rather than a partial authorization.

A system for processing a real-time discount at a point of sale includes a database, a receiving device, a processing device, and a transmitting device. The database is configured to store a plurality of deals, wherein each deal includes at least a consumer identification and a transaction modifier. The receiving device is configured to receive an authorization request for a financial transaction, wherein the authorization request includes at least a consumer identifier and a transaction amount. The processing device is configured to: verify enrollment in a discount service of a consumer associated with the consumer identifier; identify, in the database, at least one deal of the plurality of deals where the included consumer identification corresponds to the consumer identifier; and calculate a new transaction amount based on the transaction amount and the transaction modifier included in the at least one deal. The transmitting device is configured to transmit an authorization response for the financial transaction, wherein the authorization response is for the new transaction amount, and wherein the authorization response is indicated as being a final authorization rather than a partial authorization.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for processing a real-time discount at a point of sale in accordance with exemplary embodiments.

FIG. 2 is a block diagram illustrating a financial transaction processing server in accordance with exemplary embodiments.

FIG. 3 is a block diagram illustrating a deal database for use in the processing of real-time discounts in accordance with exemplary embodiments.

FIGS. 4A and 4B are a flow diagram illustrating a method for the processing of real-time discounts at point of sale in accordance with exemplary embodiments.

FIG. 5 is a flow chart illustrating a processing method of the financial transaction processing server of FIG. 2 for the processing of real-time discounts.

FIG. 6 is a block diagram illustrating system architecture of a computer system in accordance with exemplary embodiments.

FIG. 7 is a flow chart illustrating an exemplary method for processing real time discounts at the point of sale in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System

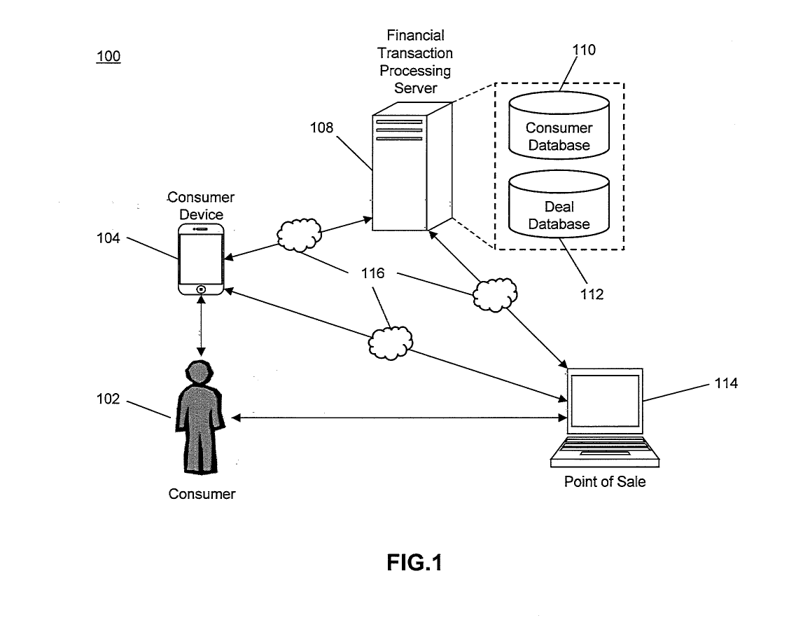

FIG. 1 illustrates a system 100 for processing real-time discounts at a point of sale 114. The system 100 may include a consumer 102 that may enroll in a discount (e.g., coupon, deal, offer, etc.) service, such as by using a consumer device 104. The consumer device 104 may be any device suitable for performing the functions as disclosed herein, such as a desktop computer, a laptop computer, a cellular phone, a smart phone, a tablet computer, a netbook, etc. The consumer 102 may enroll in the discount service with a financial transaction processing server 108.

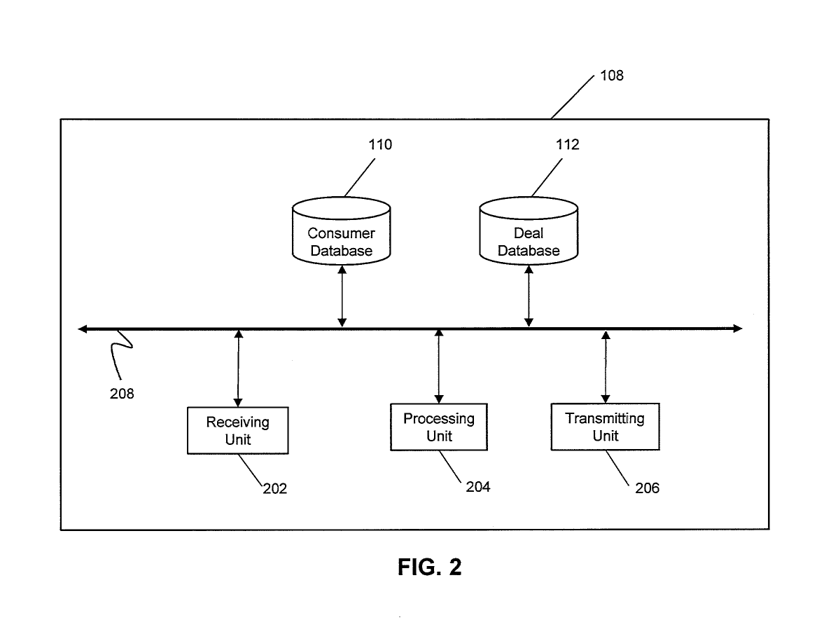

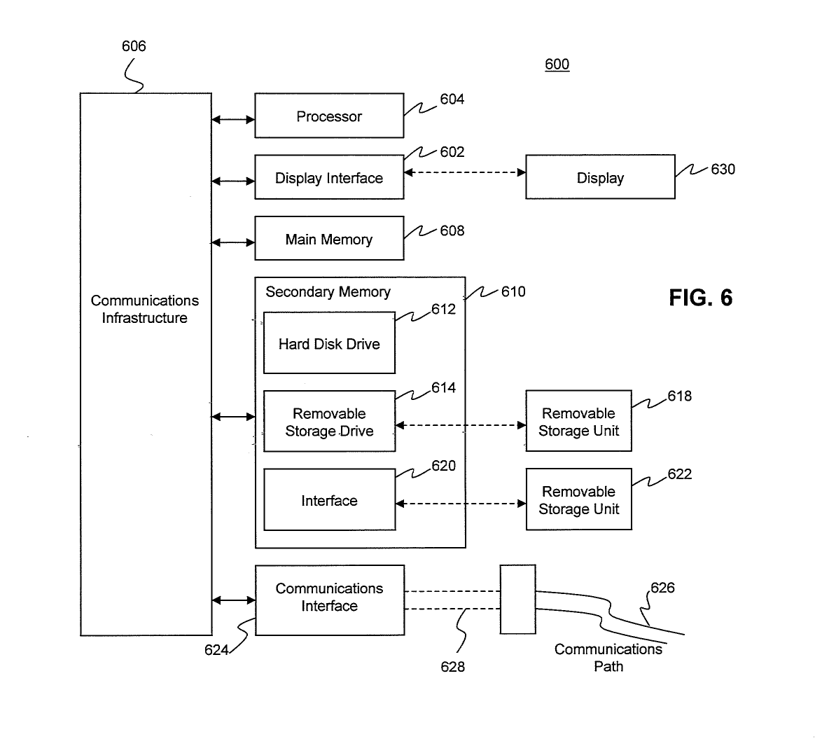

The financial transaction processing server 108 may be configured to process financial transactions including processing real-time discounts. Suitable configurations for the financial transaction processing server 108 will be apparent to persons having skill in the art and may include the processing server 108 illustrated in FIG. 2 or the computer system 600 illustrated in FIG. 6. Commercially available processing servers include those provided by MasterCard®, VISA®, American Express®, Discover®, PayPal® to name a few.

The financial transaction processing server 108 may include a consumer database 110. The consumer database 110 may be configured to store a plurality of consumer profiles, each associated with a consumer (e.g., the consumer 102). The financial transaction processing server 108 may be configured to enter a new consumer profile in the consumer database 110 once the consumer 102 has enrolled in the discount service (e.g., via the consumer device 104). Each consumer profile may include a consumer identifier and a plurality of deals distributed to the corresponding consumer 102. The consumer identifier may be a unique value associated with the consumer 102 for identification of the corresponding consumer profile. In an exemplary embodiment, the consumer identifier may be a payment account number (e.g., a payment card number) or a linked identifier corresponding to a payment account. In some embodiments, each consumer profile may also include offer redemption data, which may include data corresponding to pervious deals redeemed by the consumer 102.

The financial transaction processing server 108 may further include a deal database 112. The deal database 112, described in more detail below, may include a plurality of deals (e.g., coupons, offers, discounts, etc.) for distribution to consumers and processing in real-time. The consumer 102 may select or receive deals stored in the deal database 112, as discussed in more detail below. The consumer 102 may then engage in a financial transaction at a merchant point of sale 114. The point of sale 114 may be any point of sale device suitable for performing the functions as disclosed herein as will be apparent to persons having skill in the relevant art, such as a desktop computer, a laptop computer, a cash register, a tablet computer, a smart phone, etc.

In some embodiments, the consumer 102 may transact with the point of sale 114 at a physical location of a merchant. In other embodiments, the consumer 102 may transact with the point of sale 114 remotely, for example, by telephone, mail, or via a network 116 using the consumer device 104. The network 116 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The consumer 102 may engage in a financial transaction by providing payment details for the financial transaction to the point of sale 114. The point of sale 114 may, as part of the processing of the financial transaction, submit an authorization request for the financial transaction to the financial transaction processing server 108. The financial transaction processing server 108 may identify a consumer profile for the consumer 102 in the consumer database 110 using payment information in the submitted authorization request.

Using the consumer database 110 and/or the deal database 112, the financial transaction processing server 108 may identify a deal to be applied to the financial transaction, as discussed in more detail below. The financial transaction processing server 108 may modify the transaction amount for the financial transaction based on the identified deal and may respond to the authorization request with an authorization response for the modified transaction amount. In an exemplary embodiment, the financial transaction server 108 may indicate the authorization response as a final authorization, such that the point of sale 114 will recognize the completed financial transaction, but for the modified transaction amount. The point of sale 114 (e.g., or a merchant using the point of sale 114) may finalize the transaction with the consumer 102 (e.g., by furnishing goods, services, etc. to the consumer 102). In one embodiment, the discount may be reflected on a receipt for the transaction (e.g., printed by the point of sale 114). In a further embodiment, the authorization response may include a message for printing on the receipt. In some embodiments, the financial transaction processing server 108 may transmit a redemption message directly to the consumer 102 (e.g., via e-mail, short message service (SMS) message, etc.).

### Financial Transaction Processing Server

FIG. 2 illustrates an embodiment of the financial transaction processing server 108. The financial transaction processing server 108 may include the consumer database 110, the deal database 112, a receiving unit 202, a processing unit 204, and a transmitting unit 206. Each of the components may be connected via a bus 208. Suitable types and configurations of the bus 208 will be apparent to persons having skill in the relevant art.

Data stored in the consumer database 110 and the deal database 112 (the “databases”) may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 116).

As discussed previously, the consumer database 110 may be configured to store a plurality of consumer profiles, each consumer profile associated with a consumer (e.g., the consumer 102) and including at least a consumer identifier and a plurality of deals distributed to (e.g., clipped by, saved by, received by, etc.) the associated consumer. In some instances, the consumer database 110 may further include deal redemption data, such as data corresponding to deals previously redeemed by the consumer 102. In one embodiment, each consumer profile may be associated with a unique service (e.g., a merchant, retailer, deal service, etc.) and consumer combination such that a single consumer may be included in multiple consumer profiles, but each of those profiles may still be unique. The use of multiple consumer profiles including a unique service and consumer combination may be useful for tracking, reporting, etc. as will be apparent to persons having skill in the relevant art.

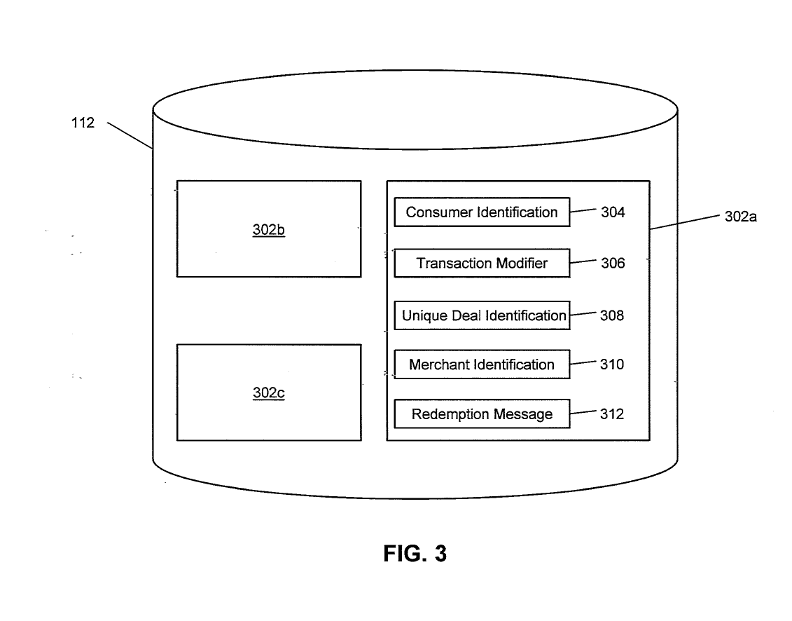

The deal database 112, discussed in more detail below with respect to FIG. 3, may be configured to store a plurality of deals for distribution to consumers and processing in real-time during financial transactions at the point of sale 114. The receiving unit 202 may be configured to receive an authorization request for a financial transaction. The authorization request may include at least a consumer identifier and a transaction amount. In some embodiments, the authorization request may include additional transaction data for the processing of the transaction or for identifying the validity of a deal as will be apparent to persons having skill in the relevant art, such as transaction time and/or date, merchant identification, industry code, geographic location, etc.

The processing unit 204 may be configured to identify in the authorization request the included consumer identifier and then identify, in the consumer database 110, the corresponding consumer profile. The processing unit 204 may be further configured to identify, in the consumer profile or in the deal database 112, at least one deal that may be applied to the financial transaction, such as based on the merchant involved in the transaction, the transaction amount, products purchased in the transaction, etc. as discussed in more detail below. In some embodiments, the processing unit 204 may identify additional data, such as past transaction data, loyalty data, etc. to identify a deal that may be applied (e.g., a free product after five previous purchases). The processing unit 204 may be configured to calculate a modified transaction amount based on the transaction amount in the authorization request and a transaction modifier for the at least one deal.

The transmitting unit 206 may be configured to transmit an authorization response, wherein the authorization response is for the modified transaction amount and is indicated as a final authorization. In some embodiments, the transmitting unit 206 may be further configured to transmit a notification of redemption of the deal to the consumer 102, such as to the consumer device 104 (e.g., via e-mail, short message service (SMS) message, etc.). In other embodiments, the transmitting unit 206 may be configured to transmit, in the authorization response, an indication of the deal, such as for display on a receipt or on the point of sale 114.

### Deal Database

FIG. 3 illustrates the deal database 112 of the financial transaction processing server 108. The deal database 112 may include a plurality of deals 302, illustrated in FIG. 3 as deal 302a, deal 302b, and deal 302c. Each deal 302 may include at least consumer identification 304, a transaction modifier 306, a unique deal identification 308, a merchant identification 310, and a redemption message 312.

The consumer identification 304 may be a unique value associated with a consumer (e.g., the consumer 102) that may correspond with a consumer identifier included in the consumer database 110. The consumer identification 304 may correspond with the consumer identifier as to enable to the processing unit 204 to identify the deal 302 as corresponding to the consumer 102 during the processing of a financial transaction.

The transaction modifier 306 may be an indicator of how the transaction amount for a financial transaction for which the deal 302 is applied should be modified. The transaction modifier 306 may be a discount amount (e.g., $5 off), a discount percentage (10% off), a variable discount for an item (e.g., buy one, get one free), or a combination thereof. In some embodiments, the transaction modifier 306 may include, or the deal 302 may further include, a minimum purchase amount. The minimum purchase amount may be an amount that must be met or exceeded by the transaction amount in order for the deal 302 to be applied to the transaction. Other types of modifiers (e.g., discounts, etc.) of the transaction modifier 306 will be apparent to persons having skill in the relevant art.

The unique deal identification 308 may be a unique value associated with the deal 302, such as for purposes of identifying the deal 302. The unique deal identification 308 may be any type of value suitable for performing the functions disclosed herein as will be apparent to persons having skill in the relevant art, such as a universal product code (UPC) or other machine-readable code, a value generated or identified by the processing unit 204, etc.

The merchant identification 310 may be a value associated with a merchant (e.g., operating the point of sale 113) with which the deal 302 may be redeemed. It will be apparent to persons having skill in the relevant art that the merchant identification 310 may be optional (e.g., the deal 302 may be used at any merchant). In some embodiments, the merchant identification 310 may include a value or values associated with multiple merchants, such as a group of merchants commonly owned and/or operated. In an alternative embodiment, the merchant identification 310 may be replaced by a manufacturer identification (e.g., a manufacturer part number, etc.) or a product identification (e.g., a universal product code, stock-keeping unit, serial number, European Article Number, etc.). In one embodiment the merchant identification 310 may be a merchant identification number (MID). In some instances, the merchant identification 310 may a category (e.g., gas, dining, etc.) such that the deal 302 may be redeemed at multiple merchants included in the corresponding category.

The redemption message 312 may be a message that is transmitted (e.g., by the transmitting unit 206) to the point of sale 114 and/or the consumer device 104 after the deal has been redeemed. In one embodiment, the redemption message 312 may be preset. In another embodiment, the redemption message 312 may be identified from a predetermined list of redemption messages. In yet another embodiment, the redemption message 312 may be determined based on a variety of factors, such as the associated consumer 102, the merchant, time and/or date of the transaction, the transaction amount, additional deals associated with the merchant, transaction history, transaction category, etc. Messages suitable to serve as the redemption message 312 will be apparent to persons having skill in the relevant art, such as a discount statement (e.g., “You just saved $20”), statement of future discount (e.g., “Save 10% on your next visit”, “spend on gas 2 more times and receive savings”, etc.), savings statement (e.g., “You have saved $520 at this merchant this year”), points statement (e.g., “You have amassed 1223 points toward your next gas purchase”), etc. Nearly any type of potential economic benefit to the consumer can be represented by the coupon, which is to be broadly understood.

Each deal 302 may further include additional data as will be apparent to persons having skill in the relevant art. For example, a deal 302 may include a start date, after which the deal 302 may be valid, or an expiration date, after which the deal 302 may not be redeemed. In one embodiment, a deal 302 may include a plurality of deal categories, such as product industry, merchant industry, geographic location, etc., which may be used in the collection of redemption data, distribution of deals to the consumer 102, or browsing of deals by the consumer 102.

### Method for Processing Real-Time Discounts

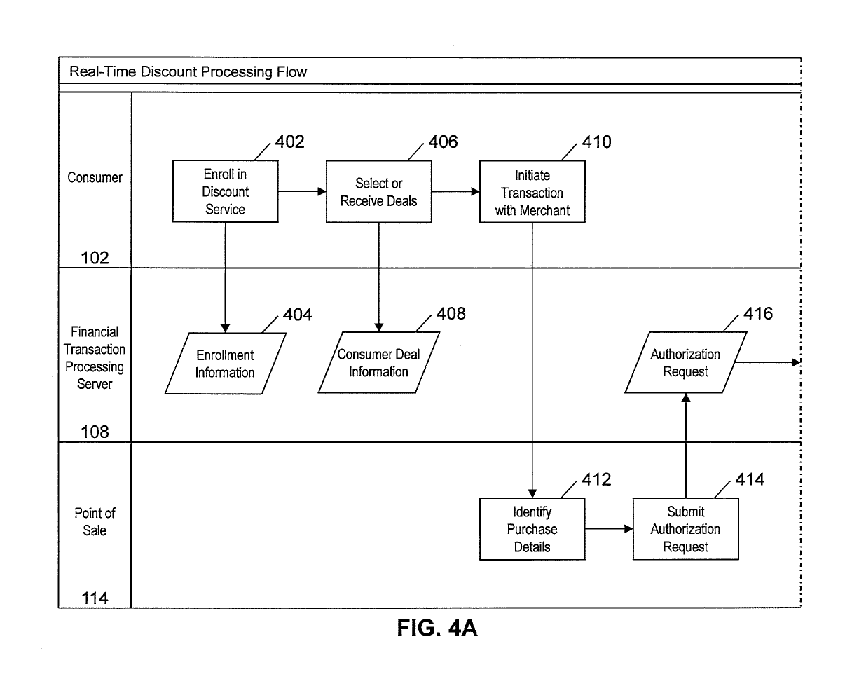

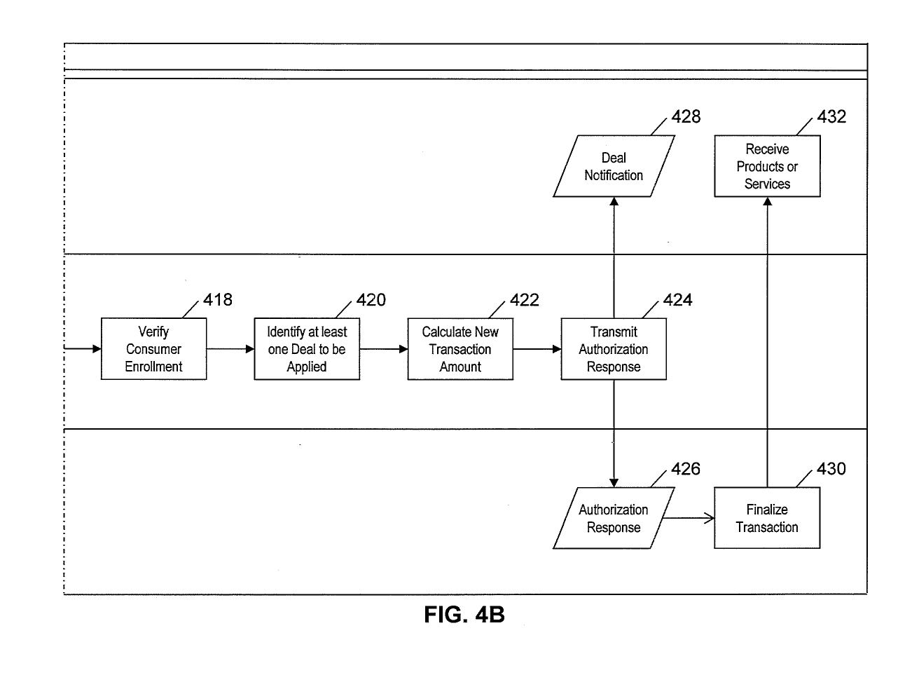

FIGS. 4A and 4B illustrate a process flow for the processing of real-time discounts at the point of sale 114 using the system 100 of FIG. 1.

In step 402, the consumer 102 may (e.g., using the consumer device 104) enroll in a discount service with the financial transaction processing server 108. In step 404, the financial transaction processing server 108 may receive the enrollment information, and may further store the received enrollment information in the consumer database 110. The enrollment information may include information identifying the consumer, such as the consumer identifier (e.g., an account number, e-mail address, phone number, username, etc.) and other information that will be apparent to persons having skill in the relevant art, such as login information for a website or application, a preferred method of distribution for deals, notification settings, receipt settings, etc.

In step 406, the consumer 102 may select or receive deals. Methods for the selection of deals by the consumer 102 or distribution of deals to the consumer 102 will be apparent to persons having skill in the relevant art, such as the consumer 102 utilizing an application or navigating to a website on a browser on the consumer device 104 to select deals to be associated with their corresponding consumer profile. For example, the consumer 102 may use an application program on the consumer device 104 to browse available deals (e.g., listed based on distance to corresponding merchants, merchant or product industry, deal value, expiration date, deal categories, etc.). In some embodiments, the consumer 102 may receive all available deals if enrolled in the discount service. The available deals may be stored in a separate database of available deals in the financial transaction processing server 108.

In step 408, the financial transaction processing server 108 may receive consumer deal information from the consumer 102 (e.g., from the application program utilized by the consumer 102) and store the information as a deal 302 in the deal database 112. The deal 302 stored in the deal database 112 may include a consumer identification 304 corresponding to the consumer identifier associated with the consumer 102, for identification of the deal 302 as being associated with the consumer 102. In step 410, the consumer 102 may initiate a financial transaction with a merchant. In one embodiment, the consumer 102 may initiate the financial transaction at a physical location of the merchant. In another embodiment, the consumer 102 may initiate the financial transaction remotely, such as through a web site associated with the merchant.

In step 412, the point of sale 114 (e.g., operated by or on behalf of the merchant) may identify purchase details. The identification of purchase details may include scanning products being purchased by the consumer 102, placing products in a virtual shopping cart, receiving input from a user as to products or services purchased by or furnished to the consumer 102, etc. The identifying or purchase details may further include receiving, from the consumer 102, payment information for funding of the financial transaction. The receiving of payment information may include scanning, reading, or receiving payment card details for a payment card associated with the consumer 102. In one embodiment, the payment card details may include a payment card number, which may be the consumer identifier of the consumer 102. In another embodiment, the purchase details may further include identified the consumer identifier associated with the consumer 102.

In step 414, the point of sale 114 may submit an authorization request for the financial transaction to the financial transaction processing server 108. The authorization request may include at least a transaction amount and a consumer identifier. In some embodiments, the authorization request may further include at least one of a merchant identifier, at least one product identifier, an industry code, a location identifier, and a time and/or date. In step 416, the financial transaction processing server 108 may (e.g., via the receiving unit 202) receive the authorization request.

In step 418, the financial transaction processing agency 108 may verify enrollment of the consumer 102 in the discount service. The verification of the enrollment may include identifying the consumer identifier in the authorization request and identifying a consumer profile in the consumer database 110 corresponding to the consumer identifier. In step 420, the financial transaction processing agency 108 may identify at least one deal 302 to be applied to the financial transaction. The identification of at least one deal 302 may include identifying, in the deal database 112, at least one deal 302 where the consumer identification 304 corresponds to the consumer identifier, and wherein any other additional requirements (e.g., merchant identification 310, product identification, manufacturer identification, start date, expiration date, minimum transaction amount, etc.) are met.

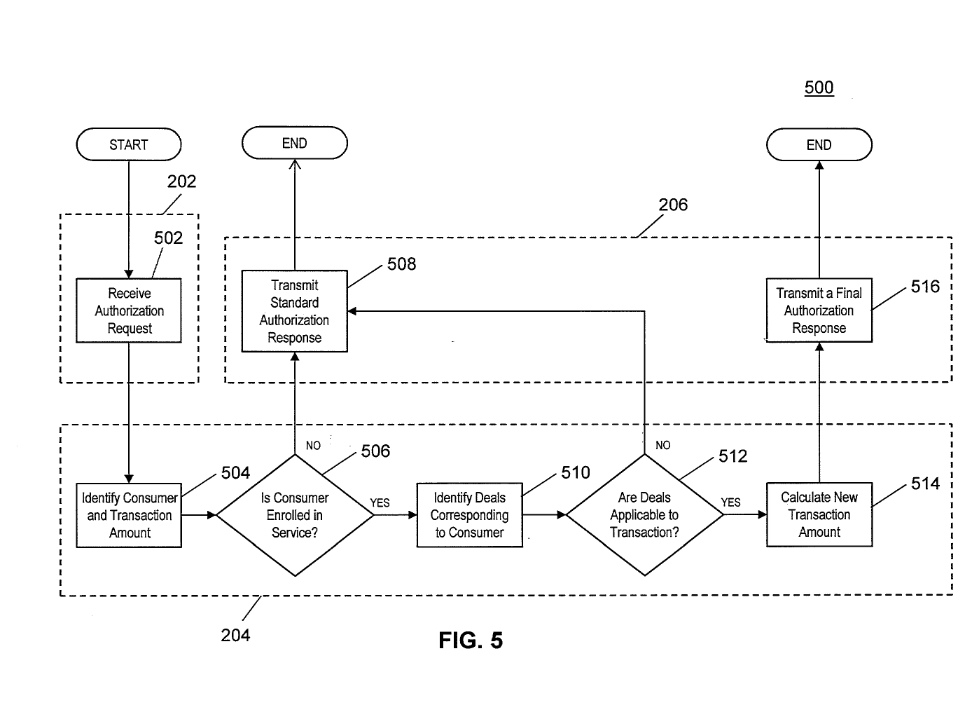

In step 422, the processing unit 204 of the financial transaction processing agency 108 may calculate a new, or modified, transaction amount for the financial transaction based on the transaction modifier 306 for each identified at least one deal. In step 424, the financial transaction processing agency 108 may (e.g., via the transmitting unit 206) transmit an authorization response to the point of sale 114, the authorization response being for the new transaction amount and being indicated as a final authorization. Additional details regarding steps 418-424 are discussed below with reference to FIG. 5.

In step 426, the point of sale 114 may receive the authorization response from the financial transaction processing agency 108. At step 428, the consumer 102 may (e.g., via the consumer device 104) receive a notification of redemption of the deal 302 from the financial transaction processing agency 108 once the authorization response is transmitted to the point of sale 114. In one embodiment, the notification of redemption may include the redemption message 312. At step 430, the point of sale 114 may finalize the transaction with the consumer 102. Finalizing the transaction may include the point of sale 114 identifying the authorization response as a final authorization (e.g., despite the transaction amount having been modified) and settling the transaction with the consumer 102.

Settling the transaction with the consumer 102 may include, in step 432, furnishing the transaction products and/or services to the consumer 102. In some embodiments, step 632 may include the furnishing of a receipt for the transaction to the consumer 102. In a further embodiment, the receipt may include an indication of the deal applied to the transaction, such as a line item showing the transaction amount modified according to the transaction modifier 310. In an even further embodiment, the receipt may display the redemption message 312 associated with the deal 302. In some embodiments, a record of the redemption of the deal by the consumer 102 may be stored in the corresponding consumer profile.

FIG. 5 illustrates a method 500 for the processing of a real-time discount in the financial transaction processing agency 108.

In step 502, an authorization request may be received by the receiving unit 202. The authorization request may include at least a consumer identifier and a transaction amount. In some embodiments, the authorization request may further include additional transaction details such as a merchant identifier, manufacturer identifier, product identifier, geographic location, industry code, etc.

In step 504, the processing unit 204 may identify the consumer identifier and transaction amount, and any other additional information, included in the authorization request. Identification of the information in the authorization request may include locating data elements inside the authorization request and identifying the data included in each of the respective data elements. Methods for identifying data elements and data included in an authorization request will be apparent to persons having skill in the relevant art.

In step 506, the processing unit 204 may determine if the consumer 102 corresponding to the identified consumer identifier is enrolled in the discount service. Determining if the consumer 102 is enrolled may include identifying, in the consumer database 110, a consumer profile that includes the identified consumer identifier. If the consumer profile is not found, and the consumer 102 is determined to not be enrolled in the discount service, then, in step 508, the transmitting unit 206 may transmit a standard authorization response. In one embodiment, the authorization response may include a message directed towards the consumer 102, such as a message inviting the consumer to enroll and/or detailing possible savings.

If a consumer profile is found, and it is therefore determined that the consumer 102 is enrolled, then the method 500 may proceed to step 510. In step 510, the processing unit 204 may identify deals 302 corresponding to the consumer 102. The identification of deals 302 may include identifying, in the deal database 112, at least one deal 302 where the consumer identification 304 corresponds to the identified consumer identifier. In some embodiments, identifying at least one deal 302 may include identifying at least one deal 302 where additional information included in the deal 302 (e.g., merchant identification 310, a product identification, a minimum transaction amount, etc.) corresponds to additional information identified in the authorization request in step 504. If no deals are identified as being valid and/or application to the transaction, then the transmitting unit 206 may transmit a standard authorization response for the financial transaction.

If at least one deal is identified, then, in step 514, the processing unit 204 may calculate a new transaction amount. The calculating of a new transaction amount may include modifying the transaction amount identified in the authorization request based on the transaction modifier 306 for each identified deal. In some embodiments, if multiple deals are applied to the transaction, the corresponding transaction modifiers 306 may be applied in a predetermined order (e.g., amount modifiers, such as $5 off, prior to percentage modifiers, such as 10% off, etc.). In other embodiments, prioritization rules may be used to identify a single transaction modifier 306 if multiple deals are applied to the transaction, such that only a single deal 302 may be used.

Once the new transaction amount has been calculated, then, in step 516, the transmitting unit 206 may transmit a final authorization response. The final authorization response may be an authorization response for the new transaction amount that is indicated as being a final authorization. Indication of the authorization response as a final authorization (e.g., as opposed to a partial authorization) may indicate to the point of sale 114 that the transaction has been approved for the new transaction amount instead of the original transaction amount, but that the transaction should be finalized, as opposed to requiring additional payment from the consumer 102. This may enable a consumer 102 and point of sale 114 to transact and have a deal be reflected in the purchase prior to the processing of the transaction such that an additional credit transaction is not needed and the savings can be reflected via a receipt at the point of sale 114.

In one embodiment, the authorization response may further include a redemption message. In some embodiments, the redemption message may include the redemption message 312 for each deal 302 applied to the transaction. In other embodiments, the redemption message may be a single message identified or generated by the processing unit 204 based on each deal 302 applied to the transaction. In some embodiments, the method 500 may further include the transmitting unit 206 transmitting a notification of redemption to the consumer 102 (e.g., via the consumer device 104). In one embodiment, the notification of redemption may be the redemption message 312 for each deal 302 applied to the transaction, or a single message identified or generated by the processing unit 204. Suitable notification messages will be apparent to persons having skill in the relevant art. The notification of redemption may be transmitted to the consumer 102 in a method determined by the consumer 102, and stored in the corresponding consumer profile in the consumer database 110.

### Computer System Architecture

FIG. 6 illustrates a computer system 600 in which embodiments of the present disclosure, or portions thereof, may be implemented as computer-readable code. For example, the consumer device 104, the financial transaction processing server 108, and the point of sale 114 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, 5 and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network (e.g., the network 116), multi-core message-passing scheme, etc. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 4A, 4B, 5 and 7, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

### Exemplary Method for Processing a Real-Time Discount at Point of Sale

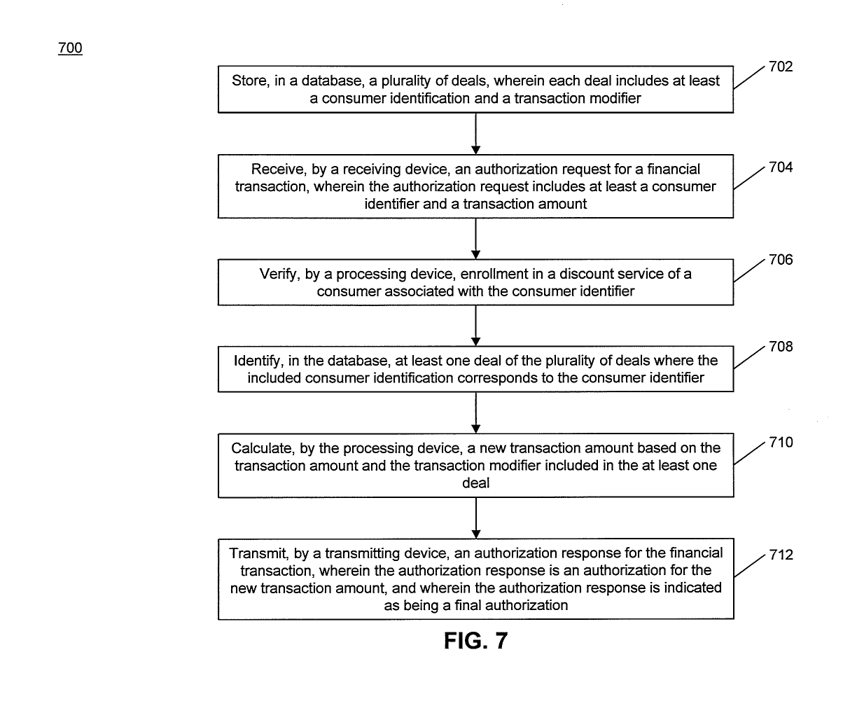

FIG. 7 illustrates a method 700 for processing a real-time discount at a point of sale (e.g., the point of sale 114).

In step 702, a plurality of deals may be stored in a database (e.g., the deal database 112), wherein each deal (e.g., the deal 302) includes at least a consumer identification (e.g., the consumer identification 304) and a transaction modifier (e.g., the transaction modifier 306). In one embodiment, the transaction modifier may be a number. In some embodiments, the consumer identification may be an account number or a number linked (e.g., associated) with an account. In a further embodiment, the account number may be a financial account number, a loyalty card number, a virtual account number, or a controlled payment number. In one embodiment, each deal 302 may further include a merchant identification (e.g., the merchant identification 310) and/or a unique deal identification (e.g., the unique deal identification 308).

In step 704, an authorization request for a financial transaction may be received by a receiving device (e.g., the receiving unit 202), wherein the authorization request includes at least a consumer identifier and a transaction amount. In one embodiment, the authorization request may further include at least one of a merchant identifier and a deal identifier. In step 706, a processing device (e.g., the processing unit 204) may verify enrollment in a discount service of a consumer (e.g., the consumer 102) associated with the consumer identifier. In one embodiment, verifying enrollment in a discount service may include identifying, in a consumer database (e.g., the consumer database 110) a data entry associated with the consumer 102.

In step 708, at least one deal 302 of the plurality of deals may be identified in the deal database 112, where the included consumer identification 304 corresponds to the consumer identifier. In embodiments where each deal 302 may include the merchant identification 310 or the unique deal identification 308, the included merchant identification 310 and/or unique deal identification 308 may also correspond to a merchant identifier or deal identifier, respectively, included in the authorization request. In step 710, the processing unit 204 may calculate a new transaction amount based on the transaction amount and the transaction modifier 306 included in the at least one deal 302.

In step 712, a transmitting device (e.g., the transmitting unit 206) may transmit an authorization response for the financial transaction, wherein the authorization response is an authorization for the new transaction amount and the authorization response is indicated as being a final authorization rather than a partial authorization. In one embodiment, the authorization response may include an indication that a discount was applied. In a further embodiment, the at least one deal 302 may include a redemption message (e.g., the redemption message 312), and the indication that a discount was applied may include the redemption message 312.

Techniques consistent with the present disclosure provide, among other features, systems and methods for processing real-time discounts at the point of sale. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a real-time discount at a point of sale, comprising:
storing, in a database, a plurality of deals, wherein each deal includes at least a consumer identification and a transaction modifier;
receiving, by a receiving device, an authorization request for a financial transaction, wherein the authorization request includes at least a consumer identifier and a transaction amount;
verifying, by a processing device, enrollment in a discount service of a consumer associated with the consumer identifier;
identifying, in the database, at least one deal of the plurality of deals where the included consumer identification corresponds to the consumer identifier;
calculating, by the processing device, a new transaction amount based on the transaction amount and the transaction modifier included in the at least one deal; and
transmitting, by a transmitting device, an authorization response for the financial transaction, wherein the authorization response is an authorization for the new transaction amount, and wherein the authorization response is indicated as being a final authorization rather than a partial authorization.

2. The method of claim 1, wherein the authorization response includes an indication that a discount was applied.

3. The method of claim 2, wherein each deal of the plurality of deals further includes a redemption message, and wherein indication that a discount was applied includes the redemption message associated with the at least one deal.

4. The method of claim 1, wherein
each deal in the plurality of deals further includes a merchant identification,
the authorization request further includes a merchant identifier, and
the merchant identification included in each deal of the at least one deal corresponds to the merchant identifier.

5. The method of claim 1, wherein
each deal in the plurality of deals further includes a unique deal identification,
the authorization request further includes a deal identifier, and
the at least one deal includes a unique deal identification that corresponds to the deal identifier.

6. The method of claim 1, wherein the transaction modifier is a number.

7. The method of claim 1, wherein the consumer identifier and the consumer identification are account numbers.

8. The method of claim 7, wherein the account numbers are at least one of: financial account numbers, loyalty card numbers, virtual account numbers, and controlled payment numbers.

9. The method of claim 1, wherein verifying enrollment in a discount service of a consumer includes identifying, in a consumer database, a data entry associated with the consumer.

10. A system for processing a real-time discount at a point of sale, comprising:
a database configured to store a plurality of deals, wherein each deal includes at least a consumer identification and a transaction modifier;
a receiving device configured to receive an authorization request for a financial transaction, wherein the authorization request includes at least a consumer identifier and a transaction amount;
a processing device configured to
verify enrollment in a discount service of a consumer associated with the consumer identifier,
identify, in the database, at least one deal of the plurality of deals where the included consumer identification corresponds to the consumer identifier, and
calculate a new transaction amount based on the transaction amount and the transaction modifier included in the at least one deal; and
a transmitting device configured to transmit an authorization response for the financial transaction, wherein the authorization response is an authorization for the new transaction amount, and wherein the authorization response is indicated as being a final authorization rather than a partial authorization.

11. The system of claim 10, wherein the authorization response includes an indication that a discount was applied.

12. The system of claim 11, wherein each deal of the plurality of deals further includes a redemption message, and wherein indication that a discount was applied includes the redemption message associated with the at least one deal.

13. The system of claim 10, wherein
each deal of the plurality of deals further includes a merchant identification,
the authorization request further includes a merchant identifier, and
the merchant identification included in each deal of the at least one deal corresponds to the merchant identifier.

14. The system of claim 10, wherein
each deal of the plurality of deals further includes a unique deal identification,
the authorization request further includes a deal identifier, and
the at least one deal includes a unique deal identification that corresponds to the deal identifier.

15. The system of claim 10, wherein the transaction modifier is a number.

16. The system of claim 10, wherein the consumer identifier and the consumer identification are account numbers.

17. The system of claim 16, wherein the account numbers are at least one of: financial account numbers, loyalty card numbers, virtual account numbers, and controlled payment numbers.

18. The system of claim 10, wherein verifying enrollment in a discount service of a consumer includes identifying, in a consumer database, a data entry associated with the consumer.
